(19) United States
(12) Patent Application Publication
(10) Pub. No.: US 2015/0142498 A1
(43) Pub. Date: May 21, 2015

(54) COMMISSIONING SYSTEM AND WORKFLOW MANAGEMENT

(71) Applicant: LATISTA Technologies, Inc., Reston, VA (US)

(72) Inventors: Patricia Remacle, Reston, VA (US); Anatoliy Tishin, Reston, VA (US)

(21) Appl. No.: 14/546,240

(22) Filed: Nov. 18, 2014

Related U.S. Application Data
(60) Provisional application No. 61/905,512, filed on Nov. 18, 2013.

(51) Int. Cl. G06Q 10/06

(52) U.S. Cl. CPC G06Q 10/06313; G06Q 10/0633
USPC 705/7.23

(57) ABSTRACT

The invention generally relates to systems and methods for providing automated process-driven workflow management during a commissioning process. A user may customize the commissioning process by way of user-generated workflow list. A user may map one or more commissioning steps to a specific component of a system, such as a component of a piece of electrical equipment, to be commissioned. The user may assign dependencies for one or more of the mapped steps, including start criteria that identify which steps must be successfully completed before a subsequent step may begin, and completion criteria, which identify what type of issues must be completely resolved before a certain step (or milestone) may be completed. Accordingly, the present invention may enable a user to generate an intuitive and automated process-driven workflow for improving the commissioning process.

This application claims priority under 35 USC §119 to U.S. Provisional Patent Application 61/905,512, entitled “COMMISSIONING SYSTEM AND WORKFLOW MANAGEMENT” filed Nov. 18, 2013, the entire contents of which are incorporated by reference.

### FIELD

The present disclosure relates generally to project management, and, more particularly, to systems and methods for providing intuitive and automated process-driven workflow management during a commissioning process.

### BACKGROUND

In general, project management is understood to include planning, organizing, motivating, and controlling resources to achieve specific goals. In the construction industry, for example, construction management firms may be engaged in medium and large projects (e.g., sport stadiums, hospitals and healthcare facilities, office buildings, power plants, manufacturing facilities, airports, seaports and railway terminals, multi-unit residential complexes, etc.). Throughout the entire process of construction (e.g., from planning to handover), large teams of construction professionals and specialists have to be managed so as to ensure that all aspects of the construction project (e.g., partnering, estimating, purchasing, scheduling, engineering, safety, community relations, etc.) go smoothly to produce high-quality projects on time.

Conventionally, coordinating such large teams involved a lot of paperwork, including documentation related to data in the field. This is especially true in performing field management, punch list management, quality, commissioning, turn-over and safety management, and warranty- and maintenance-related functions. Such documents include, but are not limited to, field inspections, punch lists, vendor lists, resource lists, and task lists. Consequently, firms have sought processes that keep their project coordinators and subcontractors on the job site working (i.e., building and maintaining), rather than in an office shuffling papers. Furthermore, the use of documentation may slow down productivity simply due to the fact that not all of the field personnel may have access to the recorded field data, thus possibly leading to work duplication, unnecessary communications, or other cost-increasing problems.

As a result, some systems have been developed that provide project management via wireless computing devices and cloud-based servers, wherein data related to construction processes (e.g. field inspection data, punch list data, commissioning data, etc) may be more easily recorded in the field (i.e., on a computing device) and more easily exchanged between personnel (i.e., synchronization of data between computing devices), thereby improving the overall construction process.

While current management systems and software may overcome some of the drawbacks of conventional construction management (i.e. paperwork and disorganization), such systems have drawbacks, particularly with regard to the commissioning process. Generally, commissioning is the process of ensuring that all (or some, depending on the scope) systems and components of a building or industrial plant are designed, installed, tested, operated, and maintained according to the operational requirements of the owner or final client. This may include verifying the subsystems for mechanical (HVAC), plumbing, electrical, fire/life safety, building envelopes, interior systems (example laboratory units), cogeneration, utility plants, sustainable systems, lighting, wastewater, controls, and building security to achieve the owner's project requirements as intended by the building owner and as designed by the building architects and engineers. In practice, the commissioning process comprises the integrated application of a set of engineering techniques and procedures to check, inspect, and test every operational component of the project, from individual functions, such as instruments and equipment, up to complex amalgamations, such as modules, subsystems and systems.

Current management systems and software may lack flexibility when carrying out certain functions, such as the commissioning process. During the commissioning process, it is important to have a defined workflow so as to ensure that the commissioning process is carried out in an orderly and efficient fashion, which may ultimately save time and money, as well as reduce risk of injury when testing certain systems or equipment. However, current systems do not provide an intuitive means of implementing workflow during the commissioning process nor do they provide a user, such as a commissioning coordinator or manager, with the ability to customize the workflow.

### SUMMARY

The present invention provides systems and methods for construction field management. In one aspect, a system is configured to provide field management services and facilitate an online platform web-application for carrying out one or more functions related to construction field management. The system is configured for use by capital business owners, commissioning agents, and construction management firms and their subcontractors/vendors for management of the construction project, wherein the application optimizes a variety of field operations, improving performance and effectiveness of mobile workers.

The system generally includes one or more mobile devices configured to communicate with a remote server or cloud-based service. The mobile devices may generally include any mobile computing device configured to run the construction field management software thereon. For example, a mobile device consistent with the present disclosure may include a tablet PC for field-based personnel configured to synchronize with the server and/or cloud-based server and dynamically exchange field data related to one or more construction processes. Each mobile device may communicate with one another, by way of the server and/or cloud-based server, such that each field-personnel has access to ongoing constructions processes and related field data.

The mobile devices may be synchronized with the server and/or cloud-based service on a regular basis to make data records consistent and up-to-date. In a synchronization process, data record changes may be propagated from one mobile device to another, via the server or cloud-based service. In one aspect, such synchronization is based on a data record replication mechanism where all the necessary data records are transmitted to mobile devices in advance. The replication mechanism then assumes that all the mobile device users may work “off-line” and go “on-line” only to connect to a server to “sync.” Mobile device users may modify or delete existing data records and add new data records to the replicated data records in the course of their field work. All user-made modifications and replication of new data records may take place during next synchronization. Synchronization also may be used to initialize any newly-installed mobile device version of the application.

In one aspect, the system may include a field management system for executing the application, wherein the field management system may be implemented on each mobile device and/or the server and/or cloud-based service. The field management system includes a commissioning module for generally managing the commissioning process. The main objective of commissioning is to effect the safe and orderly handover of a project (e.g., building) from the constructor to the owner, guaranteeing its operability in terms of performance, reliability, safety and information traceability. Additionally, when executed in a planned and effective way, commissioning normally represents an essential factor for the fulfillment of schedule, costs, safety and quality requirements of the project.

The commissioning module may generally provide a user with a means for generating and executing a workflow when performing a commissioning process. The commissioning module includes a workflow management module configured to generate and execute a process-driven workflow list based on user input. The workflow management module is configured to enable a user to customize the commissioning process by way of a user-generated workflow list. In particular, the workflow management module is configured to enable a user to map one or more steps (which may include specific tasks, tests, etc.) to a specific component of a system (e.g., component of a piece of electrical equipment). The workflow management module is further configured to enable a user to assign dependencies for one or more of the mapped steps, including start criteria, which define which steps must be successfully completed before a subsequent step may begin, and completion criteria, which define what type of issues must be completely resolved before a certain step (or milestone) may be completed.

The systems and methods consistent with the present disclosure provide an intuitive means of implementing a process-driven workflow during a commissioning process. The system allows generation of a user-defined process-driven workflow, which includes user-assigned dependencies. During the commissioning process, it is important to have a defined workflow so as to ensure that the commissioning process is carried out in an orderly and efficient fashion. For example, in the case of the testing electrical equipment, the commissioning coordinator wants to ensure that personnel do not attempt to run a functional test on a piece of electrical equipment unless such equipment has first successfully passed an Electrical Safety Inspection. Otherwise, personnel may be exposed to risk of electrocution. Furthermore, a commissioning coordinator may also wish to enforce specific conditions before declaring that certain milestones have been met (or commissioning steps completed) during the commissioning process. For example, prior to declaring a Clean Room “Room Ready”, any and all operational issues identified during the commissioning tests have to be resolved.

A workflow generated with systems and methods consistent with the present disclosure will generally ensure that the commissioning process is carried out in an orderly and efficient fashion, ensuring that certain criteria are met, in a particular order, before a subsequent commissioning step is performed, which will save time and money, as well as reduce the risk of injury when testing certain systems or equipment.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of an exemplary system for providing field management services and facilitating an online platform web-application for carrying out one or more functions related to construction field management.

FIG. 2 is a block diagram illustrating at least one embodiment of a mobile device of the system of FIG. 1 consistent with the present disclosure.

FIG. 3 is a block diagram illustrating an exemplary embodiment of a field management system for providing mobile-based field management services and communication between the mobile devices and the external computing device/system/server and/or the cloud-based service of FIG. 1.

FIG. 4 is a block diagram illustrating a portion of the field management system of FIG. 3 in greater detail.

FIG. 5 is a flow diagram illustrating one embodiment of a method for executing a generated process-driven workflow for a commissioning process of one or more components of a system.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the present disclosure is generally directed to systems and methods for construction field management. In some embodiments, the system is configured to provide field management services and facilitate an online platform web-application for carrying out one or more functions related to construction field management. The system is configured for use by capital business owners, commissioning agents and construction management firms and their subcontractors/vendors for management of the construction project. The system is configured to optimize a variety of field operations, improving performance and effectiveness of mobile workers.

The system generally includes one or more mobile devices configured to communicate with a remote server or cloud-based service. The mobile devices may generally include any mobile computing device configured to run the construction field management software thereon. For example, a mobile device consistent with the present disclosure may include a tablet PC for field-based personnel configured to synchronize with the server and/or cloud-based server and dynamically exchange field data related to one or more construction processes. Each mobile device may communicate with one another, by way of the server and/or cloud-based server, such that each field-personnel has access to ongoing constructions processes and related field data.

The mobile devices may be synchronized with the server and/or cloud-based service on a regular basis to make data records consistent and up-to-date. In a synchronization process, data record changes may be propagated from one mobile device to another, via the server or cloud-based service. In one aspect, such synchronization is based on a data record replication mechanism where all the necessary data records are transmitted to mobile devices in advance. The replication mechanism then assumes that all the mobile device users may work “off-line” and go “on-line” only to connect to a server to “sync.” Mobile device users may modify or delete existing data records and add new data records to the replicated data records in the course of their field work. All user-made modifications and replication of new data records may take place during next synchronization. Synchronization also may be used to initialize any newly-installed mobile device version of the application.

In one aspect, the system may include a field management system for executing the application, wherein the field management system includes modules for such important areas of Quality Management, Punch List Management, Safety Management, Production Tracking, Commissioning, Document Management and Report Management.

In one aspect, the application may provide a user with a means for generating and executing a workflow when performing a commissioning process for one or more components of a system. The main objective of commissioning is to effect the safe and orderly handover of a project (e.g., building) from the constructor to the owner, guaranteeing its operability in terms of performance, reliability, safety and information traceability. Additionally, when executed in a planned and effective way, commissioning normally represents an essential factor for the fulfillment of schedule, costs, safety and quality requirements of the project.

As such, during the commissioning process, it is important to have a defined workflow so as to ensure that the commissioning process is carried out in an orderly and efficient fashion, which may ultimately save time and money, as well as reduce risk of injury when testing certain systems or equipment. For example, during the commissioning process of a new building, a commissioning coordinator may want to ensure that certain criteria are met, in a particular order, before a subsequent commissioning test is performed. This is particularly important when performing a commissioning process on systems that may pose an inherent risk of injury or death.

For example, in the case of the testing electrical equipment, the commissioning coordinator wants to ensure that personnel do not attempt to run a functional test on a piece of electrical equipment unless such equipment has first successfully passed an Electrical Safety Inspection. Otherwise, personnel may be exposed to risk of electrocution. Furthermore, a commissioning coordinator may also wish to enforce specific conditions before declaring that certain milestones have been met (or commissioning steps completed) during the commissioning process. For example, prior to declaring a Clean Room “Room Ready”, any and all operational issues identified during the commissioning tests have to be resolved.

The commissioning module of the field management system, which may be implemented on each mobile device and/or the server and/or cloud-based service, includes a workflow management module configured to generate and execute a process-driven workflow list based on user input. The workflow management module is configured to enable a user to customize the commissioning process by way of user-generated workflow list. In particular, the workflow management module is configured to allow a user to map one or more steps/tests to a specific component of a system (e.g., component of a piece of electrical equipment). The workflow management module is further configured to allow a user to assign dependencies for one or more of the mapped steps, including start criteria, which define which steps must be successfully completed before a subsequent step may begin, and completion criteria, which define what type of issues must be completely resolved before a certain step (or milestone) may be completed.

The systems and methods consistent with the present disclosure provide an intuitive means of implementing a process-driven workflow during a commissioning process. The system enables generation of a user-defined process-driven workflow, which includes user-assigned dependencies. A workflow generated with systems and methods consistent with the present disclosure will generally ensure that the commissioning process is carried out in an orderly and efficient fashion, ensuring that certain criteria are met, in a particular order, before a subsequent commissioning step is performed, which will save time and money, as well as reduce the risk of injury when testing certain systems or equipment.

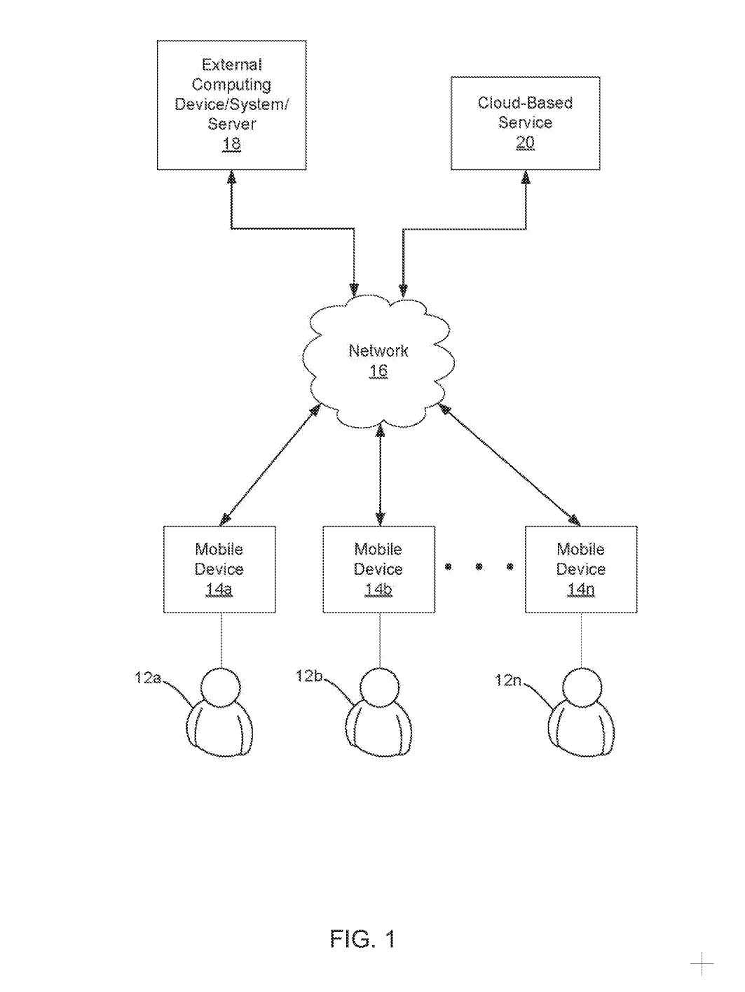

Turning to FIG. 1, one embodiment of an exemplary system for providing field management services is generally illustrated. FIG. 1 presents an exemplary environment diagram 10 of various hardware components and other features in accordance with an aspect of the present invention. As shown, in an aspect of the present invention, data and other information and services are, for example, input by one or more users 12 (shown as users 12a-12n) and received by one or more associated mobile devices 14 (shown as mobile devices 14a-14n). The mobile devices 14 are configured to be communicatively coupled to an external device, system or server 18 and/or cloud-based service 20 via a network 16. In addition, or alternatively, the mobile devices 14 are configured to be communicatively coupled to one another via the network 16.

The mobile devices 14 may be embodied as any type of device for communicating with one or more remote devices/systems/servers and for performing the other functions described herein. For example, the mobile device 14 may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a network appliance, a web appliance, a distributed computing system, a multiprocessor system, a processor-based system, a consumer electronic device, and/or any other computing device configured to store and access data, and/or to execute software and related applications consistent with the present disclosure.

In one aspect, mobile device 14 is a one of many commercially-available tablet PCs, notebook PCs or convertible notebook PCs that may be used as tablet PCs suitable for a construction jobsite where shock, extreme heat, cold, direct sunlight, dust, and rain are expected. Rugged, semi-rugged, and non-rugged tablet PCs—such as the Panasonic Toughbook, the Itronix GoBook, the Motion-Computing F5 and the Xplore Technologies iX104C2—typically offer the ability to enter data using an electronic pen, built-in software keyboard, regular external keyboard, mouse and voice dictation, and may be equipped with a digital camera. Such tablet PCs typically include the ability to program pen-activated shortcuts for complex information entry as in, for example, filling out an electronic form or report. Accordingly, systems and methods described herein, particularly the online platform web-application, are compatible with mobile operating systems (OS) for PC-based mobile devices, including, but not limited to, Android, Windows, and Blackberry. In one embodiment, the mobile device 14 may include a Windows Tablet running Windows 8 OS.

In other embodiments, the mobile device 14 is computer tablet having touchscreen capabilities. For example, the mobile device 14 is an Apple iPad®, wherein the systems and methods described herein are compatible with and configured to be executed and run on Apple operating systems (OS), including iOS 7, as well as prior versions.

It should be understood that the term “data” means any information used in an aspect. Examples include, but are not limited to, input data by users, task data, checklist data, punch list data, standard templates or other standard information, standard report elements, data records, alerts and messages, system overhead information or other internal communications, etc.

The external computing device/system/server 18 may be embodied as any type of device, system or server for communicating with the mobile devices 14 and/or the cloud-based service 20, and for performing the other functions described herein. Examples embodiments of the external computing device/system/server 18 may be identical to those just described with respect to the mobile device 14 and/or may be embodied as a conventional server, e.g., web server or the like.

The network 16 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the mobile devices 14, between the mobile devices 14 and the external computing device/system/server 18 and/or cloud-based service 20, may be, in whole or in part, a wired connection.

The network 16 may be any network that carries data. Non-limiting examples of suitable networks that may be used as network 16 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), other networks capable of carrying data, and combinations thereof. In some embodiments, network 16 is chosen from the internet, at least one wireless network, at least one cellular telephone network, and combinations thereof. As such, the network 16 may include any number of additional devices, such as additional computers, routers, and switches, to facilitate communications. In some embodiments, the network 16 may be or include a single network, and in other embodiments the network 16 may be or include a collection of networks.

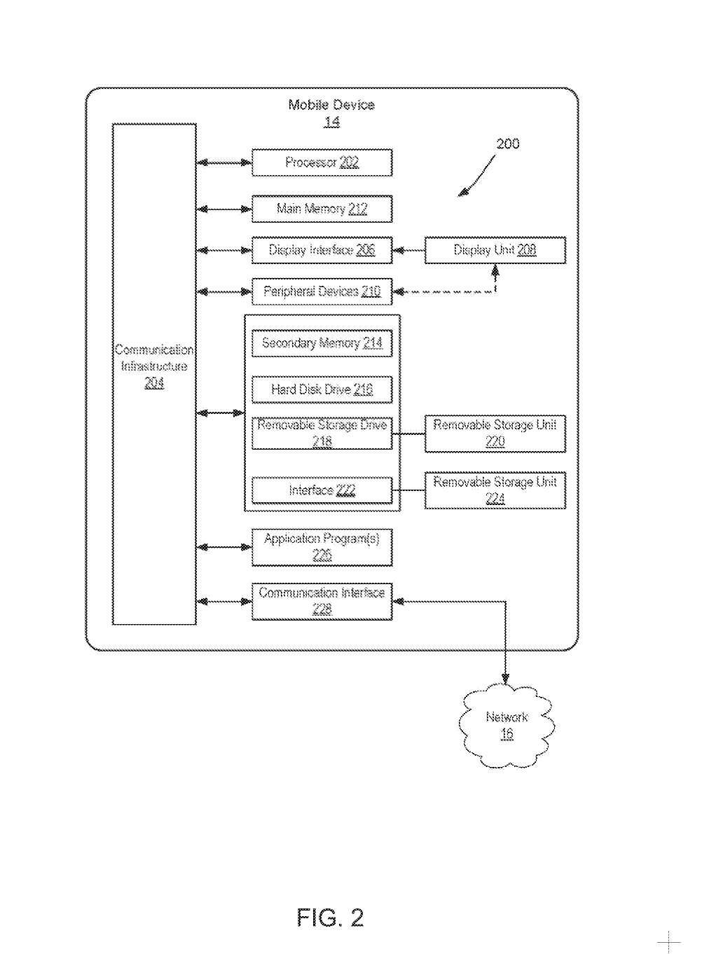

As described in greater detail herein, a computing system (see FIG. 2) may be configured to carry out the functionality described herein (e.g., field management services and facilitation of software for carrying out one or more functions related to construction field management). In one embodiment, the invention is directed toward one or more computing systems capable of carrying out the functionality described herein. An example of a computer system 200 is shown in FIG. 2. The computing system 200 of FIG. 2 may be included within the mobile device 14, for example. Additionally, or alternatively, the computing system 200 may be included within the external computing device/system/server 18 and/or cloud-based service 20. The computing system 200 includes one or more processors, such as processor 202. Processor 202 is operably connected to communication infrastructure 204 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

The computing system 200 may include display interface 206 that forwards graphics, text, and other data from communication infrastructure 204 (or from a frame buffer not shown) for display on display unit 208. The computing system further includes peripheral devices 210. The peripheral devices 210 may include one or more devices for interacting with the mobile device 14, such as a keypad and/or one or more audio speakers. In one embodiment, the display unit 208 may include a touch-sensitive display (also known as “touch screens” or “touchscreens”), in addition to, or as an alternative to, physical push-button keyboard or the like. The touch screen may generally display graphics and text, as well as provides a user interface (e.g., but not limited to graphical user interface (GUI)) through which a user may interact with the mobile device 14, such as accessing and interacting with applications executed on the device 14.

The computing system 200 also includes main memory 212, such as random access memory (RAM), and may also include secondary memory 214. The main memory 212 and secondary memory 214 may be embodied as any type of device or devices configured for short-term or long-term storage of data such as, for example, memory devices and circuits, memory cards, hard disk drives, solid-state drives, or other data storage devices. In the illustrative embodiment, the mobile device 14 may maintain one or more application programs, databases, media and/or other information in the main and/or secondary memory 212, 214. The secondary memory 214 may include, for example, a hard disk drive 216 and/or removable storage drive 218, representing a floppy disk drive, a magnetic tape drive, an optical disk drive, etc. Removable storage drive 218 reads from and/or writes to removable storage unit 220 in any known manner. The removable storage unit 220 may represents a floppy disk, magnetic tape, optical disk, etc. which is read by and written to by removable storage drive 218. As will be appreciated, removable storage unit 220 includes a computer usable storage medium having stored therein computer software and/or data.

In alternative embodiments, the secondary memory 214 may include other similar devices for allowing computer programs or other instructions to be loaded into the computing system 200. Such devices may include, for example, a removable storage unit 224 and interface 222. Examples of such may include a program cartridge and cartridge interface (such as that found in video game devices), a removable memory chip (such as an erasable programmable read only memory (EPROM), or programmable read only memory (PROM)) and associated socket, and other removable storage units 224 and interfaces 222, which allow software and data to be transferred from removable storage unit 224 to the computing system 200.

The computing system 200 may also include one or more application programs 226 directly stored thereon. The application program(s) 226 may include any number of different software application programs, each configured to execute a specific task. For example, in one embodiment, the application program 226 may include construction field management software for providing field management services and facilitating an online platform web-application for carrying out one or more functions related to construction field management.

The computing system 200 may also include a communications interface 228. The communications interface 228 is configured to allow data to be transferred between the computing system 200 and external devices (other mobile devices 14, external computing device/system/server 18, cloud-based service 20). Examples of communications interface 228 may include a modem, a network interface (such as an Ethernet card), a communications port, a Personal Computer Memory Card International Association (PCMCIA) slot and card, etc.

Computer programs (also referred to as computer control logic) may be stored in main memory 212 and/or secondary memory 214 or a local database on the mobile device 14. Computer programs may also be received via communications interface 228. Such computer programs, when executed, enable the computing system 200 to perform the features of the present invention, as discussed herein. In particular, the computer programs, including application programs 226, when executed, enable processor 202 to perform the features of the present invention. Accordingly, such computer programs represent controllers of computer system 200.

In one embodiment where the invention is implemented using software, the software may be stored in a computer program product and loaded into the computing system 200 using removable storage drive 218, hard drive 216 or communications interface 228. The control logic (software), when executed by processor 202, causes processor 202 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

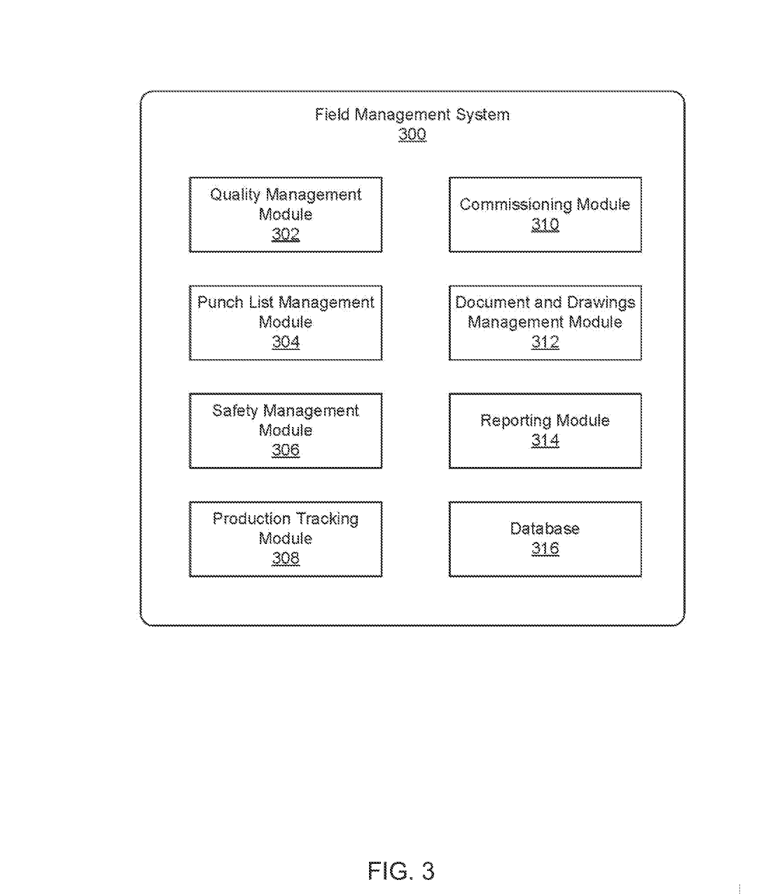

Referring to FIG. 3, an exemplary embodiment of a field management system 300 is generally illustrated. The field management system 300 is configured to generally provide one or more field management services, including, but not limited to, issue tracking, field reporting, materials tracking, safety, quality assurance (QA) and quality control (QC), work list, commissioning, punch list, production tracking, and document and drawings management. Accordingly, the field management system 300 may include a quality management module 302, punch list management module 304, safety management module 306, production tracking module 308, commissioning module 310, document and drawings management module 312, and reporting module 314. Each of the modules 302-314 is configured to provide users, when executing the software application, access to and exchange of field data in conjunction with the desired process. The field management system 300 further includes a database 316 for storing resources related to one or more of the field management services. The resources may include, but are not limited to, checklists, checkboxes, descriptions, data items, information templates, equipment lists, report templates, histories, images, etc.

The field management system 300 is generally configured to communicate and operate in conjunction with the computing system 200 of FIG. 2. Accordingly, in some embodiments, the field management system 300 is incorporated within the mobile devices 14. Additionally, or alternatively, the field management system 300 may be part of the external device, system or server 18 and/or cloud-based service 20.

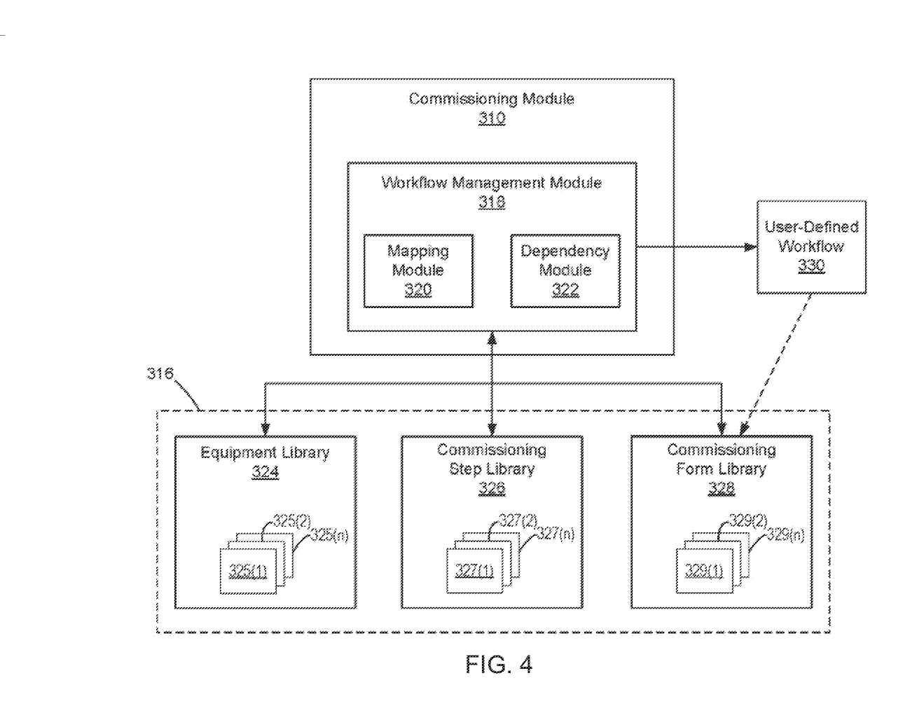

FIG. 4 is a block diagram illustrating the commissioning module 310 of the field management system 300 of FIG. 3 in greater detail. As shown, the commissioning module 310 includes a workflow management module 318 configured to generate a user-defined process-driven workflow 330 based on input from a user 12, generally in control of and/or having responsibility for overseeing and managing one or more field management services. For example, systems and methods consistent with the present disclosure may allow a commissioning coordinator to create a specific workflow of any particular component of a system, such as an electrical system within a newly construction building. The workflow management module 318 is generally configured to allow the coordinator to set up the commissioning process, specifically the workflow of the commissioning process. Generation of a user-defined workflow 330 is generally performed on the server side of the system, wherein the user-defined workflow 330, once created, may then be synchronized with one or more of the mobile devices 14, thereby enabling the enforcement of the user-defined workflow 330 for a specific component or system on the mobile devices 14.

In the illustrated embodiment, the workflow management module 318 includes a mapping module 320 and a dependency module 322. As described in greater detail herein, the mapping module 320 is configured to enable the coordinator to map a specific component (e.g. piece of equipment) of a system to undergo the commissioning process with a specific step (e.g., functional test), in a particular order, so as to generally create a workflow that dictates progression of the commissioning process as a whole. The dependency module 322 generally allows the coordinator to optionally define dependencies between steps. The dependencies may include, for example, start criteria, which defines which steps must be successfully completed before a subsequent step may begin, and completion criteria, which defines what type of issues must be completely resolved before a certain step (or milestone) may be completed. Accordingly, during the commissioning process of electrical equipment, for example, the user-defined process-driven workflow may ensure that that personnel do not attempt to run a functional test on a piece of electrical equipment unless such equipment has first successfully passed an Electrical Safety Inspection, as dictated by the dependencies assigned to the specific step, as described above. Upon mapping steps to components and generating step/component pairs and optionally further assigning dependencies for the steps, the workflow management module 318 generates a user-defined process-driven workflow 330 to generally dictate the process of the commissioning process.

As shown in FIG. 4, a commissioning coordinator may access one or more libraries containing data stored in the database 316, for example, for use in creating a user-defined workflow for any given commissioning process. In particular, the coordinator may have access to a plurality of equipment profiles 325(1)-325(n) stored in an equipment library 324, a plurality of steps 327(1)-327(n) stored in a commissioning step library 326, and a plurality of interactive commissioning forms 329(1)-329(n) stored in a commissioning form library 328. Generally, the coordinator may first define a series of commissioning steps (e.g. tests) for any particular commissioning process. Accordingly, the coordinator utilizes one or more steps 327 from the commissioning step library 326 for any particular system to be commissioned, including the individual components of such system. At this point, the coordinator may also define dependencies between the steps, such as start criteria and/or completion criteria.

The coordinator may then access and design one or more interactive commissioning forms 329 from library 328. The interactive forms 329 are used to capture the results of each commissioning step in a workflow on the mobile device 14. The interactive form 329 may include, for example, a GUI presented on a display of a mobile device 14 and mimic a paper document generally used in the commissioning process. However, the interactive form 329 allows input by way of touchscreen and further provides functions not otherwise available on a paper document (e.g., filter and sorting, task data, image presentation, real-time updating, etc.). As an example, a user conducting a Functional Test on an electrical piece of equipment will record the results on an Electrical Test form and an individual conducting a Functional Test (step) on a mechanical piece of equipment will record results on a Mechanical Test form. These two forms are created in as interactive forms so they may be filled out electronically on the mobile device 14.

The coordinator may further access a plurality of components 325 from the equipment library 324. In one embodiment, the system may be configured to allow the coordinator to define a hierarchal equipment structure, or tree, related to systems that require commissioning. For example, the coordinator may define a hierarchal equipment tree representing rooms>systems within the rooms>components which make up the systems (i.e., that require commissioning). For each entry in the equipment tree, the coordinator may define which steps 327 in the commissioning process must be completed. In particular, the mapping module 320 is configured to assign one or more steps 327 to a particular component 325, thereby creating step(s)/component pairings. For instance, a Clean Room may go through only Construction Complete and Room Ready but an individual component may require Design Verification, Construction Complete, Electrical Safety Inspection, Functional Test, and Emergency Test. Furthermore, for each step(s)/component pairing, the mapping module 320 is further configured to allow the coordinator to define a form 329 to be used on the particular component 325.

In some instances, the equipment library 324 may include a large amount of data (e.g., thousands of pieces of equipment 325) from which the coordinator may choose. Likewise, the coordinator may have a large number of steps 327 to choose from and assign with each piece of equipment 325. Accordingly, generation of a user-defined workflow 330 may be quite extensive, as systems and methods consistent with the present disclosure are configured to handle large amounts of data, including the large number of different variations for generating a user-defined workflow 330. Accordingly, to simplify the setup, systems and methods consistent with the present disclosure provide the ability to setup templates for different types of equipment that may be setup once and then applied to multiple items in the equipment tree. For example, a coordinator may set up a particular workflow template for any given piece of equipment. The workflow template may include specific steps, optionally including dependencies between one or more of the steps, and the particular interactive form to be used. For example, a coordinator may set up a template for Air Handling Units that define what steps must be conducted on an AHU (Air Handling Unit) and further define what forms must be used for each step. The template may be saved (e.g., stored in the database 316) and may be applied to AHU1-AHU100 (assuming there are a hundred Air Handling Units in the building) in future commissioning processes when needed. Thus, a coordinator need not create a new workflow each time.

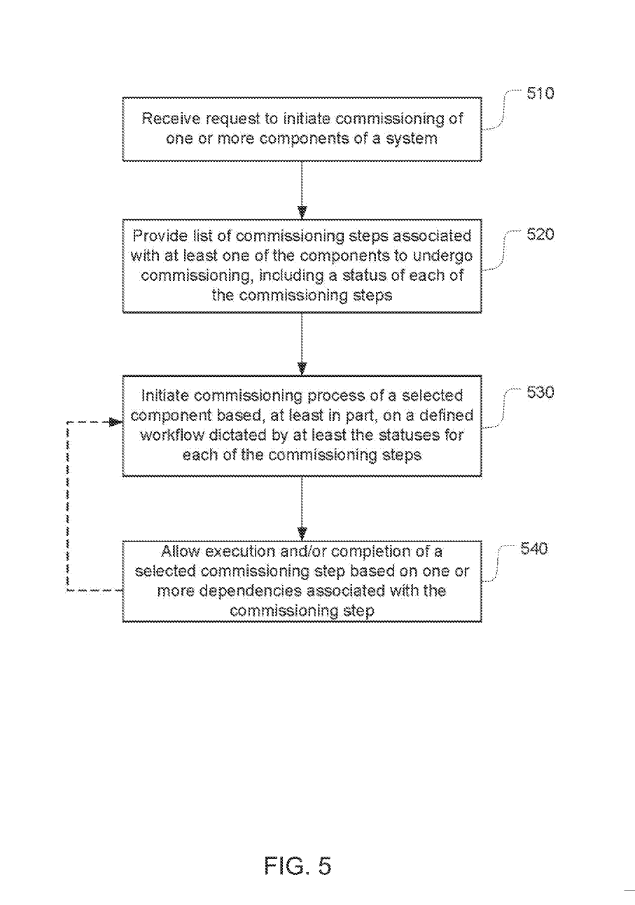

FIG. 5 is a flow diagram of a method 500 for executing a generated process-driven workflow for a commissioning process of one or more components of a system, is generally illustrated. The method 500 includes receiving request to initiate commissioning of one or more components of a system (operation 510). A user, such as field personnel, may request initiation of the commissioning via a mobile device configured to execute and run an online platform web-application for carrying out one or more functions related to construction field management, including, but not limited to, commissioning. The user may select a piece of equipment from an equipment library that requires commissioning. For example, the user may use a GUI on their mobile device to scroll and select from a list of equipment. Additionally, or alternatively, the user may scan a bar code on a particular piece of equipment, which, in turn, pulls up a corresponding equipment profile.

The method 500 further includes providing a list of commissioning steps associated with at least one of the components that the user requested to be commissioned (operation 520). Each of the steps may include a status associated therewith. For example, each step may have a status selected from not started (step has not be performed), in process (step is currently in process), passed (step has been performed and passed), and failed (step has been performed and failed). The method further includes initiating the commissioning process for a selected component based, at least in part, on the defined workflow associated with the commissioning process, as well as the status for any given commissioning step (operation 530). For example, a user may select a particular step to perform, such as a Functional Test of a piece of electrical equipment. The method further includes allowing execution and/or completion of a selected commissioning step based on one or more dependencies associated with the commissioning step (operation 540). One or more commissioning steps may include dependencies associated therewith. The dependencies may generally dictate the order with which the steps may be carried out. For example, a start criteria dependency may define which steps must be successfully completed before a subsequent step may begin and a completion criteria dependency may define what type of issues must be completely resolved before a certain step (or milestone) may be completed.

While FIG. 5 illustrates method operations according various embodiments, it is to be understood that in any embodiment not all of these operations are necessary. Indeed, it is fully contemplated herein that in other embodiments of the present disclosure, the operations depicted in FIG. 5 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it may be appreciated that the logic flow merely provides an example of how the general functionality described herein may be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

A field management system may be provided where the system includes a commissioning module that includes a workflow management module. The workflow management module may include a mapping module and a dependency module. The mapping module may be configured to create a mapping in a database in response to user input, where the mapping is between a multiple commissioning steps in a predefined order and a component of a system to be commissioned in a commissioning process. The dependency module may be configured to set a dependency between two or more of the commissioning steps in response to user input. The workflow management module may be configured to generate a user-defined workflow based on the mapping of the commissioning steps and the dependency that was set in response to user input. The user-defined workflow may dictate a progression of the commissioning process of the system to be commissioned and/or of the component of the system to be commissioned.

The commissioning module may be further configured to enforce the user-defined workflow during the commissioning process. The workflow management module may be further configured to transmit the user-defined workflow to a mobile device on which the commissioning process is performed in accordance with the user-defined workflow.

The user-defined workflow may be synchronized with one or more mobile devices on which the user-defined workflow is enforced in a commissioning of the system to be commissioned and/or of the component of the system to be commissioned. The component of the system to be commissioned may include, for example, a system of a building and/or of an industrial plant.

The database may include a library of one or more interactive commissioning forms. The workflow management module may be configured to modify one or more interactive commissioning forms in response to user input. Each of the interactive forms may be configured to capture user input during performance of a corresponding one of the commissioning steps.

The database may include, for example, an equipment library and a commissioning step library. The equipment library may include descriptions of multiple pieces of equipment. The commissioning step library may include predefined commissioning steps. The component to be commissioned may be selected from the pieces of equipment in the equipment library in response to user input. Alternatively or in addition, the commissioning steps are selected for the mapping from the predefined commissioning steps in response to user input.

Anon-transitory computer readable storage medium may be provided that includes computer executable instructions that are executable by a processor, such as the processor 202 in the mobile device 14 or a processor in a server. The computer executable instructions may be executable to generate a pairing, in response to user input, of multiple commissioning steps to a component that is to be commissioned. The computer executable instructions may be executable to establish a dependency of a first one of the commissioning steps on a second one of the commissioning steps in response to user input. The computer executable instructions may be executable to generate a user-defined workflow based on the user-established dependency and on the user-pairing of the commissioning steps of the component. The computer executable instructions may be executable to enforce the user-defined workflow during commissioning of a system that includes the component.

The computer executable instructions may be executable to assign one or more predetermined steps selected from a library of steps to the component in response to user input. In some examples, the dependency includes a start criteria, where the start criteria indicates a first one of the commissioning steps must be successfully completed before a second one of the commissioning steps is allowed to begin. Alternatively or in addition, the dependency may include a completion criteria that identifies what type of issues must be completely resolved before a commissioning step completes.

The computer executable instructions may be executable to create a workflow template for a type of equipment in response to user input. The workflow template may include an association between the type of equipment and the commissioning steps. The user-pairing of the commissioning steps to the component may be based on the component being the type of equipment for which the workflow template is created. In some examples, the workflow template may include an association between each of the commissioning steps and a corresponding interactive form.

A method for commissioning a system may be provided. A user-defined mapping between commissioning steps and a component of the system may be created. A user-defined dependency between two or more of the commissioning steps may be created. A user-defined workflow may be generated based on the user-defined mapping of the commissioning steps and the user-defined dependency. The system may be commissioned in an order dictated by the user-defined workflow.

Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Each component may include additional, different, or fewer components. For example, the field management system 300 may only include the commissioning module 310. In another example, the mobile device 14 may only include the processor 202, the main memory 212, the communication infrastructure 204, and the display unit 208. In still another example, the cloud-based service 20 may include a server that include a processor and a memory, where the memory includes the commissioning module 310.

The system 300 may be implemented in many different ways. Each module, such as the commissioning module 310, the database 316, the workflow management module 318, the mapping module 320, and the dependency module 322, may be hardware or a combination of hardware, software, and/or firmware. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of the memory 212, for example, that comprises instructions executable with the processor 202 or other processor to implement one or more of the features of the module. When any of the modules includes the portion of the memory that comprises instructions executable with the processor, the module may or may not include the processor. In some examples, each module may only be the portion of the memory 212 or other physical memory that comprises instructions executable with the processor 202 or other processor to implement the features of the corresponding module without the module including any other hardware. Because each module includes at least some hardware even when the included hardware comprises software and/or firmware, each module may be interchangeably referred to as a hardware module.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL)).

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various modifications of the invention and many further embodiments thereof, in addition to those shown and described herein, will become apparent to those skilled in the art from the full contents of this document.

What is claimed is:

1. A field management system comprising:
a commissioning module comprising a workflow management module, the workflow management module comprising:
a mapping module configured to create a mapping in a database in response to user-provided input, wherein the mapping is between a plurality of commissioning steps in a predefined order and a component of a system to be commissioned in a commissioning process; and
a dependency module configured to set a dependency in the database between two or more of the commissioning steps in response to a user-identified dependency, wherein the workflow management module is configured to generate a user-defined workflow based on the mapping of the commissioning steps and on the dependency, wherein the user-defined workflow specifies a progression of the commissioning process of the system to be commissioned, of the component of the system to be commissioned, or both.

2. The system of claim 1, the commissioning module is further configured to enforce the user-defined workflow during the commissioning process.

3. The system of claim 1, wherein the workflow management module is further configured to transmit the user-defined workflow to a mobile device, wherein the user-defined workflow on the mobile device enables the mobile device to enforce the user-defined workflow for the component.

4. The system of claim 1, wherein the user-defined workflow is synchronized with one or more mobile devices on which the user-defined workflow is enforced in a commissioning of the system to be commissioned, of the component of the system to be commissioned, or both.

5. The system of claim 1, wherein the component of the system to be commissioned includes a system of a building, of an industrial plant, or both.

6. The system of claim 1, wherein the database comprises a library including an interactive commissioning form, wherein the workflow management module is further configured to modify the interactive commissioning form in response to user-provided form modification input, wherein the interactive form is configured to capture user-provided field data during performance of a corresponding one of the commissioning steps.

7. The system of claim 1, wherein the database comprises an equipment library and a commissioning step library, the equipment library comprising descriptions of multiple pieces of equipment, the commissioning step library comprising multiple predefined commissioning steps, wherein the component to be commissioned is selected from the pieces of equipment in the equipment library in response to a first user selection, and the commissioning steps are selected for the mapping from the predefined commissioning steps in response to a second user selection.

8. A non-transitory computer readable storage medium comprising computer executable instructions, the computer executable instructions executable by a processor, the computer executable instructions comprising:
instructions executable to generate a pairing of a plurality of commissioning steps to a component that is to be commissioned based on commissioning user input;
instructions executable to establish a dependency of a first one of the commissioning steps on a second one of the commissioning steps based on dependency user input;
instructions executable to generate a user-defined workflow based on the user-established dependency and on the user-based pairing of the commissioning steps to the component; and
instructions executable to enforce the user-defined workflow during commissioning of a system that includes the component.

9. The computer readable storage medium of claim 8, wherein the component is equipment.

10. The computer readable storage medium of claim 8 further comprising instructions executable to assign one or more predetermined steps selected from a library of steps to the component in response to user input.

11. The computer readable storage medium of claim 8, wherein the dependency includes a start criteria, and the start criteria indicates that at least the first one of the commissioning steps must be successfully completed before a second one of the commissioning steps is allowed to begin.

12. The computer readable storage medium of claim 8, wherein the dependency includes a completion criteria that identifies an issue that must be completely resolved before a commissioning step completes.

13. The computer readable storage medium of claim 8 further comprising instructions executable to create a workflow template for a type of equipment in response to user input, the workflow template comprising an association between the type of equipment and the plurality of commissioning steps, wherein the user-established pairing of the commissioning steps to the component is based on the component being the type of equipment for which the workflow template is created.

14. The computer readable storage medium of claim 13, wherein the workflow template further comprises an association between each of the commissioning steps and a corresponding interactive form.

15. A method for commissioning a system, the method comprising:
creating, by a processor, a user-defined mapping in a database between a plurality of commissioning steps and a component of the system;
creating, by the processor, a user-defined dependency in the database between two or more of the commissioning steps;
generating, by the processor, a user-defined workflow based on the user-defined mapping of the commissioning steps and the user-defined dependency; and
commissioning, by the processor, the system in an order identified by the user-defined workflow.

16. The method of claim 15, wherein the database comprises a library including an interactive commissioning form, the method further comprising modifying the interactive commissioning form in response to user-provided form modification input, wherein the interactive form is configured to capture user-provided field data during performance of a corresponding one of the commissioning steps.

17. The method of claim 15 further comprising:
providing an equipment library and a commissioning step library in the database, the equipment library comprising descriptions of multiple pieces of equipment, the commissioning step library comprising multiple predefined commissioning steps;
selecting the component to be commissioned from the pieces of equipment in the equipment library in response to a first user selection; and
selecting the commissioning steps for the mapping from the predefined commissioning steps in response to a second user selection.

18. The method of claim 15, wherein the user-defined dependency includes a completion criteria that identifies an issue that must be resolved before a commissioning step completes.

19. The method of claim 15 further comprising creating a workflow template for a type of equipment in response to user input, the workflow template comprising an association between the type of equipment and the plurality of commissioning steps, wherein the user-defined mapping of the commissioning steps to the component is based on the component being the type of equipment for which the workflow template is created.

20. The method of claim 19, wherein the workflow template further comprises an association between each of the commissioning steps and a corresponding interactive form.
